(19) United States
(12) Patent Application Publication
(10) Pub. No.: US 2019/0167394 A1
(43) Pub. Date: Jun. 6, 2019

(54) TOOTH CUTTING GUIDE OR TOOTH RIDGE LAP GUIDE AND METHOD OF MANUFACTURING THE SAME

(71) Applicant: Kulzer GmbH, Hanau (DE)

(72) Inventors: Joshua David Jakson, Williamsville, NY (US); John Orfanidis, Williamsville, NY (US); Colin Anthony Chiarmonte, Cheektowaga, NY (US); P. Christopher Holden, Orchard Park, NY (US)

(21) Appl. No.: 15/828,525

(22) Filed: Dec. 1, 2017

(51) Int. Cl. A61C 13/08; A61C 13/00; A61C 13/097

(52) U.S. Cl. CPC A61C 13/081; A61C 13/34; A61C 13/097; A61C 13/0019

(57) ABSTRACT

A tooth cutting guide or tooth ridge lap guide for processing at least one prefabricated artificial tooth from a set of prefabricated artificial teeth using a subtractive processing method, the tooth cutting guide comprising a base body, at least one retainer for receiving and positioning the at least one prefabricated artificial tooth, which is formed in the base body, wherein an inner surface of each of the at least one retainer form fits to a first surface area of one of the at least one prefabricated artificial tooth from the set of prefabricated artificial teeth, and at least one through hole which is located in the at least one retainer, wherein the at least one through hole exposes at least a part of a basal surface or an occlusal surface of the one of the at least one prefabricated artificial tooth if inserted into the corresponding retainer.

Also disclosed is a method for manufacturing at least one tooth cutting guide or tooth ridge lap guide for processing prefabricated artificial teeth and a method for producing a denture using first said method.

### BACKGROUND OF THE INVENTION

### Field of the Invention

The invention relates to tooth cutting guide or a tooth ridge lap guide for processing at least one prefabricated artificial tooth of a set of prefabricated artificial teeth using a subtractive processing method to prepare a denture from a denture base and the set of prefabricated artificial teeth. The invention also relates to a method for manufacturing at least one tooth cutting guide or tooth ridge lap guide for processing prefabricated artificial teeth and a method for producing a denture using the first said method.

### Related Technology

The conventional procedure is the analog production of dentures (sometimes also called dental prostheses) built from denture base and a set of prosthesis teeth or artificial teeth. In most cases an analog process is used to produce the dental base, in which first an impression is taken of the toothless jaw of the patient. From this impression, a plaster model of the patient's oral cavity situation is prepared.

Next, a function model of the prosthesis made of wax is built up on the plaster model and fitted with artificial teeth. In most cases prefabricated artificial teeth are used and are processed by the dental technician to suit to the oral cavity situation and to the patient.

A hollow mold or casting mold is then built up by embedding the wax prosthesis in a cuvette with plaster, silicone or gel (depending on the later processing technique) in order to then release the wax base from the mold after hardening the embedding material in order to create a cavity for the prosthetic plastic. In most cases the artificial teeth remain inserted into the hollow mold. A plastic which has the color of the gum is inserted in the mold, and during the casting process the artificial teeth are bonded to the denture base. Once the plastic has cured it undergoes further working in order to obtain the desired surface quality. By using this technique, a denture having artificial teeth is obtained.

As well as manual craft techniques, digital manufacturing methods are increasingly gaining in importance in the dental sector. Dental restoration work, such as crowns and bridges, has for some years been produced in a subtractive manner with milling procedures by means of CAD/CAM technologies (CAM—Computer-Aided Manufacturing, CAD—Computer-Aided Design).

A CAD/CAM process for producing a dental prosthesis is known from WO 91/07141 A1, wherein, with this process, prosthesis base is milled out of a plastic block on the basis of an impression.

In addition, generative CAM processes such as SLM (Selective Laser Melting) are steadily growing in importance for the production of crowns, bridges, and models, as well as stereolithography and DLP (digital light processing) for dental products on a polymer base, such as, for example, temporary fittings, prostheses, gnatho-orthopedic apparatus, bite guards, drill templates or dental models. In this context, the production of dentures on an acrylate base by means of RP processes (Rapid Prototyping processes) has hitherto been subjected to increasingly tight restrictions. Multi-colored dentures or dentures made from a variety of different polymer materials (such as for enamel and dentine compounds) for the production of high-quality and aesthetic dentures have hitherto only been feasible by means of elaborate and expensive RP machines with multiple material chambers, or by means of adhesive bonding and jointing techniques.

Likewise, the production of material combinations (such as CoCr and polymer) by means of RP processes has hitherto been very elaborate and expensive, and has not been put into large-scale effect. The generative production of aesthetically demanding artificial teeth for partial or total prostheses is not possible at the present time, since by means of stereolithography only one material or one color can be printed. The printing of multicolored artificial teeth is not possible at the present time. For this reason, the prosthesis base is produced by means of CAM processes (such as milling, SLA, DLP or printing) and prefabricated artificial prosthesis teeth are adhesively bonded to the prosthesis base.

There are already preliminary methods, such as the methods known from U.S. Pat. No. 9,295,534 B2 or WO 2013/124 452 A1, with which a dental part or total prosthesis is created digitally and produced by CAD/CAM processes. US 2015/0216638 A1 discloses a method with which a dental arch is connected to a mold-making compound material, wherein the compound is contained in an individualized impression tray, and contains an impression of the oral cavity situation of the patient. The surface of the mold with the dental arch is digitalized and then, by means of computerized techniques, a virtual model of the dental arch is positioned and oriented as accurately as possible in the virtual model of the prosthesis base. During the subsequent production, the prosthesis teeth must be individually and manually checked for a correct match in the tooth sockets provided in the prosthesis base in order for them to be subsequently adhesively bonded in place, wherein, as the instrument for carrying out the check, a transfer template can be used. US 2017/265971 A1 describes a method for manufacturing a dental prosthesis using a template, which is generated to allow a multitude plurality of artificial teeth to be placed and fixed to a denture base at a certain position in a defined orientation relative to one another. From U.S. Pat. No. 8,506,299 B2 a method is known for producing dentures with which a virtual arrangement of the teeth into a virtual model is carried out, and the production of a prosthesis base is then carried out on the basis of the virtual model. WO 2016/110 392 A1 discloses a method for the production of a denture in which a plastically deformable connecting means is inserted into tooth compartments of a prosthesis base in order to enable a manual correction of the orientation of the prosthesis teeth in the prosthesis base.

With regard to the production of removable dentures, such as full and partial dentures, which were produced with the aid of digital data with a CAD design, there are technical solution concepts for separating the data of the virtual models of the denture base and the artificial teeth. The denture base can in this situation be produced by an additive or also subtractive production process. As artificial teeth, consideration can be given to prefabricated artificial plastic teeth but also to individually produced artificial teeth or whole dental arches. In every case, tooth sockets must be provided in the denture base to accommodate these artificial teeth, into which, in a subsequent manual production step, the artificial teeth or dental arches are secured, for example by adhesive bonding.

The technical problem in the design of digital dentures is establishing the proper occlusal plane. The occlusal plane is established by ensuring the artificial teeth (tooth) is in the correct X-, Y-, Z-plane. As such, and because the artificial tooth is a fixed shape, the design, while dynamic, must account for a fixed, physical artificial tooth shape. In order to adjust for the necessary and proper placement of the artificial tooth, some necessary and accurate adjustment to the artificial tooth must be made in accordance with the designed denture prosthesis. At times, the basal and or occlusal surface will need to be re-shaped.

From US 2014/087327 A1 a method is known with which artificial teeth are embedded in a retaining element in wax and then undergo basal milling using a fully automated computer-controlled milling machine according to a virtual model of the artificial teeth. A tooth cutting process is used which leverages a fixed placement of the artificial tooth in a wax frame. The tooth or teeth to be cut are then abraded on a milling machine. The milled artificial teeth are released from the wax and then inserted into a denture base and adhesively bonded there in order to produce a denture. The process described above allows for digital process (accurate) to be employed but does so in a customized manner that is both affordable and simple to conduct in a manual process. This allows for a skilled technician to reduce the artificial tooth structure (shape) while utilizing some professional skill and knowledge to take into consideration knowledge the mill alone cannot compensate for.

This method has the disadvantage that the milling machine is expensive and not all dental labs have access to such a fully automated computer-controlled milling machine. The basal outer shape to match the artificial teeth must be calculated for each artificial tooth. Because of this, the locations and orientations of the individual artificial teeth in the wax block must be determined in order for them to be basally abraded with a fully automatic computer-controlled milling process. As the wax has to be removed as well the method is time consuming and not highly efficient. The expensive fully automated computer-controlled milling machine is blocked for other operations for a long time and the milling heads are worn down. Because of this, such methods are costly.

### SUMMARY

The object of the invention therefore consists of overcoming the disadvantages of the prior art. In particular, an equipment and a method is to be provided with which a simple, cost efficient and rapid production of the denture can be carried out and especially with which artificial teeth can be processed to be transferred in a shape so they can be easily inserted into an individually formed denture base. In this situation, it is intended that modern computer-controlled processes can be applied, and existing data and techniques can be used to the greatest extent possible. At the same time a simple and easy possibility to cut the prefabricated artificial teeth shall be given, by which a dental technician is able to make use of the benefits of modern CAD-methods without the need of expensive fully automated computer-controlled milling machines. The benefits of an easy design of the denture by CAD shall be preserved.

The objects of the invention are solved by a tooth cutting guide or tooth ridge lap guide according to claims 1 and 16 and a method for manufacturing at least one tooth cutting guide or tooth ridge lap guide according to claim 30 and a method for manufacturing a denture according to claim 34.

The objects of the invention are therefore solved by a tooth cutting guide or tooth ridge lap guide for processing at least one prefabricated artificial tooth from a set of prefabricated artificial teeth using a subtractive processing method, the tooth cutting guide or tooth ridge lap guide comprising a base body, at least one retainer for receiving and positioning the at least one prefabricated artificial tooth, which is formed in the base body, wherein an inner surface of each of the at least one retainer form fits to a first surface area of one of the at least one prefabricated artificial tooth from the set of prefabricated artificial teeth, and at least one through hole which is located in the at least one retainer, wherein the at least one through hole exposes at least a part of a basal surface or an occlusal surface of the one of the at least one prefabricated artificial tooth if inserted into a corresponding retainer.

It is preferred that at least a part of the basal surface of the one of the at least one prefabricated artificial tooth is exposed. Thereby the basal surface can be milled or grinded and the occlusal side remains unimpaired. Thereby the functionality of the dental cusps of the prefabricated artificial teeth remain intact and in full function. However, it can also be favorable to expose at least a part of the occlusal surface if only a small amount of material needs to be removed from the occlusal side of the prefabricated artificial teeth—say a thickness of less than 0.5 mm—because thereby it can be ensured that the basal side fits precisely to the socket in the denture base.

It can be provided that the at least one prefabricated artificial tooth is insertable from a first side of the base body into the at least one retainer and at least the part of the basal surface or the occlusal surface of the one of the at least one prefabricated artificial tooth is processable from a second side of the base body opposite the first side of the base body, if the at least one prefabricated artificial tooth is inserted into the corresponding retainer.

Thereby it can be ensured to easily insert the at least one prefabricated artificial tooth into the at least one retainer. At the same time the at least one through hole in the at least one retainer can be formed very small as the prefabricated artificial teeth do not need to be inserted through these through holes.

According to a preferred embodiment of the invention it can be provided that the base body is produced using a CAM method or is printed using a 3D printer.

Hereby it can be achieved that the benefits of modern computer aided methods and existing data of virtual models of the denture, the artificial teeth or the like can be gained using the tooth cutting guide or tooth ridge lap guide.

Hereby it can be provided that the base body is produced using a CAD method which is calculated from: A) a virtual denture model which fits to a specific patient and the virtual denture model is separated into a virtual model of a denture base and at least one virtual model of the at least one processed artificial tooth which is processable from the at least one prefabricated artificial tooth using the subtractive processing method and B) at least one virtual model of the set of prefabricated artificial teeth.

In the at least one virtual model of the at least one processed artificial tooth which are processable from the multitude plurality of prefabricated artificial teeth not all virtual processed artificial teeth need to be processed, if more than one processed artificial tooth is used. Some of them may remain unchanged compared to the outer shape of the prefabricated artificial teeth. As the technical expert will understand, it is possible to use a single virtual model for a whole multitude plurality of processed artificial teeth or for a group of processed artificial teeth or as well as a single virtual model for each of a multitude of processed artificial teeth.

Preferably, the virtual models are 3D virtual models.

By these means it is possible to use data, which is already present in modern CAD methods for designing dentures, to create a virtual model of the tooth cutting guide or tooth ridge lap guide. Therefore, it is possible to use a simple and cost-efficient CAM method to manufacture the tooth cutting guide or tooth ridge lap guide according to the invention.

According to another preferred embodiment it can be provided, that a basal part or an occlusal part of the one of the at least one prefabricated artificial tooth protrudes through the at least one through hole, if the one of the at least one prefabricated artificial tooth is inserted into the corresponding retainer.

Hereby the protruding part can be reached and removed easily for the technician or the worker. Furthermore, the part which is to be removed can be more easily recognized.

It can also be provided that the base body is made from a plastic material or a printing resin.

Plastic material and printing resin can easily be formed and so the tooth cutting guide or tooth ridge lap guide be manufactured at low cost. The base body can be easily 3D printed using printing resin.

Hereby it can be provided that the plastic material or the printing resin has a hardness which is lesser than a hardness of the material of the at least one prefabricated artificial tooth.

Hereby the technician working on the at least one prefabricated artificial tooth is able to “feel” a difference when accidently milling or cutting the tooth cutting guide or tooth ridge lap guide instead of the tooth. For this purpose, it can preferably be provided that the plastic material or the printing resin has a hardness which has a hardness which is at least 30% or at least 50% lower than the hardness of the at least one prefabricated artificial tooth.

Further it can be provided that the inner surface of the at least one retainer form fits the one of the at least one prefabricated artificial tooth bordering on the at least one through hole.

Hereby it can be ensured that the inserted prefabricated artificial tooth is firmly fixed in the corresponding retainer, resulting in a good hold and making it easier for the technician to cut or mill the prefabricated artificial tooth. At the same time the material of the tooth cutting guide or tooth ridge lap guide in the area of the through hole is close to the inserted prefabricated artificial tooth without sticking out. Thereby making it easier to work on the exposed surface of the prefabricated artificial tooth in the through hole.

It can also be provided that the material of the base body has a strength of less than 1 mm in the area of the at least one retainer which covers the basal surface or the occlusal surface of each of the at least one prefabricated artificial tooth if inserted into the corresponding retainer.

Hereby the material of the tooth cutting guide or tooth ridge lap guide in the area of the through hole is thin in the areas bordering the through hole to the inserted prefabricated artificial tooth without being bulky and thereby making it easier to work on the exposed surface of the prefabricated artificial tooth in the through hole.

It is preferred that the base body has a color or surface eliciting a visible contrast to the at least one prefabricated artificial tooth.

By this measure it is easier for the worker or technician to visually distinguish between the inserted at least one prefabricated artificial tooth and the tooth cutting guide or tooth ridge lap guide.

According to a preferred embodiment of the invention it can be provided that the tooth cutting guide or tooth ridge lap guide further comprises a holding element, which holds the at least one specific prefabricated artificial tooth in the at least one retainer.

By this means, the at least one prefabricated artificial tooth cannot easily fall out of the retainer, if such a holding element is used. This makes it easier to work on the at least one prefabricated artificial tooth in the tooth cutting guide or tooth ridge lap guide.

Hereby it can be provided that the holding element is fixed or fixable to the base body by fixing means.

Thereby the tooth cutting guide or tooth ridge lap guide, the fixing means and the at least one prefabricated artificial tooth build a single component made of fixed parts, which makes it easier to handle.

Hereby it can further be provided that the fixing means are part of the holding element or part of the base body or part of both, holding element and base body.

Preferably the fixing means are a one-piece part of the holding element or of the base body or of both the holding element and the base body.

This reduces the amount of necessary parts.

In addition, it can be provided that the holding element comprises at least one recess, each one for each of the at least one prefabricated artificial tooth, wherein an inner surface of each of the at least one recess form fits to a second surface area of one of the at least one prefabricated artificial tooth from the set of prefabricated artificial teeth.

This measure helps to firmly fix the at least one prefabricated artificial tooth in the tooth cutting guide or tooth ridge lap guide.

Hereby it can be provided that the second surface area of the one of the at least one prefabricated artificial tooth is located on the opposite side of the first surface area of the one of the at least one prefabricated artificial tooth, which form fits the inner surface of each of the at least one retainer.

Hereby the at least one prefabricated artificial tooth is clamped by the tooth cutting guide or tooth ridge lap guide from two opposing sides resulting in a stable hold of the at least one prefabricated artificial tooth.

The objects of the present invention are also met by a tooth cutting guide or tooth ridge lap guide for processing at least two prefabricated artificial teeth of a set of prefabricated artificial teeth using a subtractive processing method, the tooth cutting guide or tooth ridge lap guide comprising a base body, a multitude plurality of retainers for receiving and positioning a multitude plurality of prefabricated artificial teeth which are formed in the base body, wherein the inner surfaces of each retainer form fits to a first surface area of one of the multitude plurality of prefabricated artificial teeth from the set of prefabricated artificial teeth, and at least two through holes which are located in more than one of the plurality of retainers, wherein the at least two through holes each expose at least a part of a basal surface or an occlusal surface of at least two of the multitude plurality of prefabricated artificial teeth if inserted into a corresponding retainer.

It is preferred that at least a part of the basal surfaces of the at least two of the multitude plurality of prefabricated artificial teeth is exposed. Thereby the basal sides can be milled or grinded and the occlusal sides remains unimpaired. Thereby the functionality of the dental cusps of the prefabricated artificial teeth remain intact and in full function. However, it can also be favorable to expose at least a part of the occlusal surfaces if only a small amount of material needs to be removed from the occlusal side of the prefabricated artificial teeth—say a thickness of less than 0.5 mm—because thereby it can be ensured that the basal sides fit precisely to the sockets in the denture base.

Hereby it can be provided that the prefabricated artificial teeth are insertable from a first side of the base body into the retainers and at least the part of the basal surface or the occlusal surface of the at least two of the multitude plurality of prefabricated artificial teeth are processable from a second side of the base body opposite the first side of the base body.

Thereby it can be ensured to easily insert the at least two prefabricated artificial teeth into the retainers. At the same time the at least two through holes in the retainers can be formed very small as the prefabricated artificial teeth do not need to be inserted through these through holes.

It can further be provided that the base body is produced using a CAM method or is printed using a 3D printer.

Hereby it can be achieved, that the benefits of modern computer aided methods and existing data of virtual models of the denture, the artificial teeth or the like can be gained using the tooth cutting guide or tooth ridge lap guide. Preferably the CAM method is a generative CAM method.

According to e preferred embodiment it can be provided that the base body is produced using a CAD method which is calculated from A) a virtual denture model which fits to a specific patient and the virtual denture model is separated into a virtual model of a denture base and at least one virtual model of a multitude plurality of processed artificial teeth which are processable from the multitude plurality of prefabricated artificial teeth using the subtractive processing method and B) virtual models of the set of prefabricated artificial teeth.

In the at least one virtual model of the multitude plurality of processed artificial teeth which are processable from the multitude plurality of prefabricated artificial teeth not all virtual processed artificial teeth need to be processed. Some of them may remain unchanged compared to the outer shape of the prefabricated artificial teeth. As the technical expert will understand, it is possible to use a single virtual model for the whole multitude plurality of processed artificial teeth or for a group of processed artificial teeth or as well as a single virtual model for each of the multitude plurality of processed artificial teeth.

Preferably, the virtual models are 3D virtual models.

By these means it is possible to use data, which is already present in modern CAD methods for designing dentures, to create a virtual model of the tooth cutting guide or tooth ridge lap guide. Therefore, it is possible to use a simple and cost-efficient CAM method to manufacture the tooth cutting guide or tooth ridge lap guide according to the invention.

It can also be provided that a basal part or an occlusal part of the at least two of the multitude plurality of prefabricated artificial teeth protrude through the at least two through holes if the at least two of the multitude plurality of prefabricated artificial teeth are inserted into the corresponding retainers.

Hereby the protruding parts can be reached and removed easily for the technician or the worker. Furthermore, the parts which are to be removed can be more easily recognized.

Preferably, the base body is made from a plastic material or a printing resin.

Plastic material or the printing resin can easily be formed and so the tooth cutting guide or tooth ridge lap guide be manufactured at low cost. The base body can be easily 3D printed using printing resin.

Hereby it can be provided that the plastic material or the printing resin has a hardness which is lesser than a hardness of the material of the prefabricated artificial teeth.

Hereby the technician working on the at least two prefabricated artificial teeth is able to “feel” a difference when accidently milling or cutting the tooth cutting guide or tooth ridge lap guide instead of the teeth. For this purpose, it can preferably be provided that the plastic material or the printing resin has a hardness which has a hardness which is at least 30% or at least 50% lower than the hardness of the at least two prefabricated artificial teeth.

According to the present invention it can also be provided that the inner surfaces of the retainer's form fit the at least two prefabricated artificial teeth bordering on the at least two through holes.

Hereby it can be ensured, that the inserted prefabricated artificial teeth are firmly fixed in the corresponding retainers, resulting in a good hold and making it easier for the technician to cut or mill the at least two prefabricated artificial teeth. At the same time the material of the tooth cutting guide or tooth ridge lap guide in the area of the through hole is close to the inserted prefabricated artificial teeth without sticking out. Thereby making it easier to work on the exposed surfaces of the prefabricated artificial teeth in the through holes.

It can be provided that the material of the base body has a strength of less than 1 mm in the area of the multitude plurality of retainers which covers the basal surface or the occlusal surface of the multitude plurality of prefabricated artificial teeth if inserted into the corresponding retainer.

Hereby the material of the tooth cutting guide or tooth ridge lap guide in the area of the through holes is thin in the areas bordering the through holes to the inserted prefabricated artificial teeth without being bulky and thereby making it easier to work on the exposed surfaces of the prefabricated artificial teeth in the through holes.

According to another embodiment of the invention the base body has a color or surface eliciting a visible contrast to the at least two prefabricated artificial teeth.

By this measure it is easier for the worker or technician to visually distinguish between the inserted at least two prefabricated artificial teeth and the tooth cutting guide or tooth ridge lap guide.

According to a preferred embodiment it can be provided that the tooth cutting guide or tooth ridge lap guide further comprises a holding element, which holds the multitude plurality of prefabricated artificial teeth in the multitude plurality of retainers.

By this means, the multitude plurality of prefabricated artificial teeth cannot easily fall out of the retainers, if such a holding element is used. This makes it easier to work on the at least two prefabricated artificial teeth in the tooth cutting guide or tooth ridge lap guide.

It can further be provided that the holding element is fixed or fixable to the base body by fixing means.

Thereby the tooth cutting guide or tooth ridge lap guide, the fixing means and the multitude plurality of prefabricated artificial teeth build a single component made of fixed parts, which makes it easier to handle.

Hereby it can be provided that the fixing means are part of the holding element or part of the base body or part of both, holding element and base body.

Preferably the fixing means are a one-piece part of the holding element or of the base body or of both the holding element and the base body.

This reduces the amount of necessary parts.

It can also be provided that the holding element comprises a multitude plurality of recesses, each one for each of the multitude plurality of prefabricated artificial teeth, wherein an inner surface of each of the recesses form fits to a second surface area of one of the multitude plurality of prefabricated artificial teeth from the set of prefabricated artificial teeth.

This measure helps to firmly fix the multitude plurality of prefabricated artificial teeth in the tooth cutting guide or tooth ridge lap guide.

Hereby it can be provided that the second surface area of the one of the multitude plurality of prefabricated artificial teeth is located on the opposite side of the first surface area of each one of the multitude plurality of prefabricated artificial teeth, which form fits the inner surface of each retainer in the base body.

Hereby the multitude plurality of prefabricated artificial teeth are clamped by the tooth cutting guide or tooth ridge lap guide from two opposing sides resulting in a stable hold of the prefabricated artificial teeth.

The objects of the present invention are solved by a method for manufacturing at least one tooth cutting guide or tooth ridge lap guide for processing prefabricated artificial teeth, the method comprising the following steps:

A) calculating a virtual model of a denture based on data from a virtual model of an oral cavity of a patient and data of virtual models of prefabricated artificial teeth from a set of prefabricated artificial teeth,

B) separating the virtual model of the denture into a virtual model of a denture base and a virtual model of processed prefabricated artificial teeth such that the virtual model of the processed prefabricated artificial teeth form fits to sockets in the virtual model of the denture base,

C) calculating a difference in shape of the virtual model of the processed prefabricated artificial teeth compared to the virtual model of the prefabricated artificial teeth,

D) calculating at least one virtual model of at least one tooth cutting guide or tooth ridge lap guide from the virtual model of the prefabricated artificial teeth and the calculated difference in shape, wherein each of the at least one virtual model of the tooth cutting guide or tooth ridge lap guide comprises a virtual model of a base body which comprises or which each comprise retainers for each of the prefabricated artificial teeth,

E) calculating inner surfaces of each retainer to have a form fit to a first surface area of the virtual model of the prefabricated artificial teeth in areas where there is no difference in shape compared to the virtual model of the processed prefabricated artificial teeth,

F) calculating through holes into the virtual model of the at least one tooth cutting guide or tooth ridge lap guide inside the virtual model of the base body, the through holes being located in the retainers, wherein borders of the through holes being defined by boundaries of the difference in shape of the virtual model of the processed prefabricated artificial teeth compared to the virtual model of the prefabricated artificial teeth, and

G) manufacturing the at least one tooth cutting guide or tooth ridge lap guide by a CAM method.

Hereby the following additional steps can be provided: calculating the virtual model of the denture by defining a contact area for the virtual model of the denture base, which is calculated from the virtual model of the oral cavity of the patient, placing the virtual models of the prefabricated artificial teeth inside the virtual model of the oral cavity taking patient specifics into account, calculating the virtual model of the denture by adding volume to the contact area such that the virtual models of the prefabricated artificial teeth are embedded on their base side and such that interdental papilla are formed, and calculating the virtual model of the processed prefabricated artificial teeth by basally shortening the virtual models of the prefabricated artificial teeth or by occlusally shortening and moving the virtual models of the prefabricated artificial teeth in an occlusal direction such that the virtual model of the denture base gains a minimum thickness and sockets are formed which basally form fit the virtual model of the processed prefabricated artificial teeth in areas. Patient specifics, which can be taken into account, can preferably be the occlusion or the articulation of the patient.

Hereby the benefits of a computer controlled process for designing the denture are used and combined with the method according to the present invention to manufacture the at least one tooth cutting guide or tooth ridge lap guide.

Furthermore, it can be provided calculating a virtual model of at least one holding element as an additional part of the virtual model of the at least one tooth cutting guide or tooth ridge lap guide, locating a multitude plurality of recesses in the virtual model of the at least one holding element, each one for each of the prefabricated artificial teeth, wherein an inner surface of each of the recesses form fits to a second surface area of one of the virtual models of the processed prefabricated artificial teeth.

By these means the available data is further used for manufacturing a holding element as part of the at least one tooth cutting guide or tooth ridge lap guide, by which the prefabricated artificial teeth can be hold firmly in the tooth cutting guide or tooth ridge lap guide.

Preferably it can also be provided that the virtual model of the at least one tooth cutting guide or tooth ridge lap guide is calculated to either be

1) one virtual model of one tooth cutting guide or tooth ridge lap guide for each of the prefabricated artificial teeth or

2) one or more virtual models of at least two tooth cutting guides or of at least two tooth ridge lap guides for groups of at least two of the prefabricated artificial teeth or

3) one virtual model of one tooth cutting guide or tooth ridge lap guide for all of the prefabricated artificial teeth.

By these means single one or groups or the whole prefabricated artificial teeth can be subtractively processed and the virtual model for preparing the at least one tooth cutting guide or tooth ridge lap guide takes the outcome into account.

Methods according to the invention by which a denture is manufactured can further provide placing the prefabricated artificial teeth in the retainers of the at least one tooth cutting guide or tooth ridge lap guide, subtractively processing the prefabricated artificial teeth in areas which are exposed by the through holes, manufacturing a denture base by using a CAM method based on the virtual model of the denture base, inserting and fixing the processed prefabricated artificial teeth into sockets of the denture base.

By this method the benefits for generating the at least one tooth cutting guide or tooth ridge lap guide can be used for the denture to be produced. Thereby, the method will accurately aid in correct tooth reduction so they will fit any denture base desired from a wax try-in, injected, printed, poured, or milled base.

The invention is based on the surprising finding that by using a tooth cutting guide or tooth ridge lap guide having through holes at locations which need subtractive processing the prefabricated artificial teeth can easily be processed and cut manually by a dental technician or worker using simple milling machines. The tooth cutting guide or tooth ridge lap guide can be quickly printed or produced by another cost efficient generative CAM-method, using the data from a virtual model produced by CAD, which can easily be obtained from an already existing CAD model of the denture and the prefabricated artificial teeth. Therefore, the present invention offers the opportunity to make use of the benefits of dentures designed by CAD, without having the need for expensive machinery to process the prefabricated artificial teeth.

The tooth cutting guide or tooth ridge lap guide thereby allows for simple, accurate and affordable execution of adjustments which are necessary to allow the proper placement of the artificial teeth in the denture base. In addition, the process according to the invention is faster and more economical than the ones known from the state of the art.

The tooth cutting guide or tooth ridge lap guide can be used in connection with the digital denture design and manufacturing process. Whereby, the tooth cutting guide or tooth ridge lap guide is custom designed and printed for each individual prosthesis allowing for the manufacturing technician or worker to accurately cut either the basal side of the artificial tooth or the occlusal side of the artificial tooth so that the tooth fits the denture prosthetic either on the intaglio surface side or against the opposing dentition side (natural dentition or artificial).

### BRIEF DESCRIPTION OF THE DRAWINGS

Further embodiments of the invention will now be explained with reference to eleven schematic Figures below, however without limiting the invention, wherein:

FIG. 1 shows a schematic perspective side view on two tooth cutting guides or tooth ridge lap guides according to the invention;

FIG. 2 shows a schematic perspective view on top of a tooth cutting guide or tooth ridge lap guide according to the invention;

FIG. 3 shows a schematic perspective view on top of a tooth cutting guide or tooth ridge lap guide according to FIG. 1 with prefabricated artificial teeth inserted;

FIG. 4 shows a schematic side view on a holding element of a tooth cutting guide or tooth ridge lap guide;

FIG. 5 shows a schematic perspective view on a tooth cutting guide or tooth ridge lap guide according to the present invention;

FIG. 6 shows a virtual model for generating a tooth cutting guide or tooth ridge lap guide according to the present invention;

FIG. 7 shows a tooth cutting guide 4 or tooth ridge lap guide made from the virtual model according to FIG. 6;

FIG. 8 shows a schematic perspective side view on a different tooth cutting guide or tooth ridge lap guide according to the invention with prefabricated artificial teeth inserted;

FIG. 9 shows a schematic perspective view on top of a tooth cutting guide or tooth ridge lap guide according to FIG. 8 with no prefabricated artificial teeth;

FIG. 10 shows a schematic perspective view on a base body of a further different tooth cutting guide or tooth ridge lap guide according to the invention; and

FIG. 11 shows a schematic perspective view on the tooth cutting guide or tooth ridge lap guide according to FIG. 10.

For the sake of comparability and simplicity the same reference numbers are partially used also for different but similar embodiments.

### DETAILED DESCRIPTION

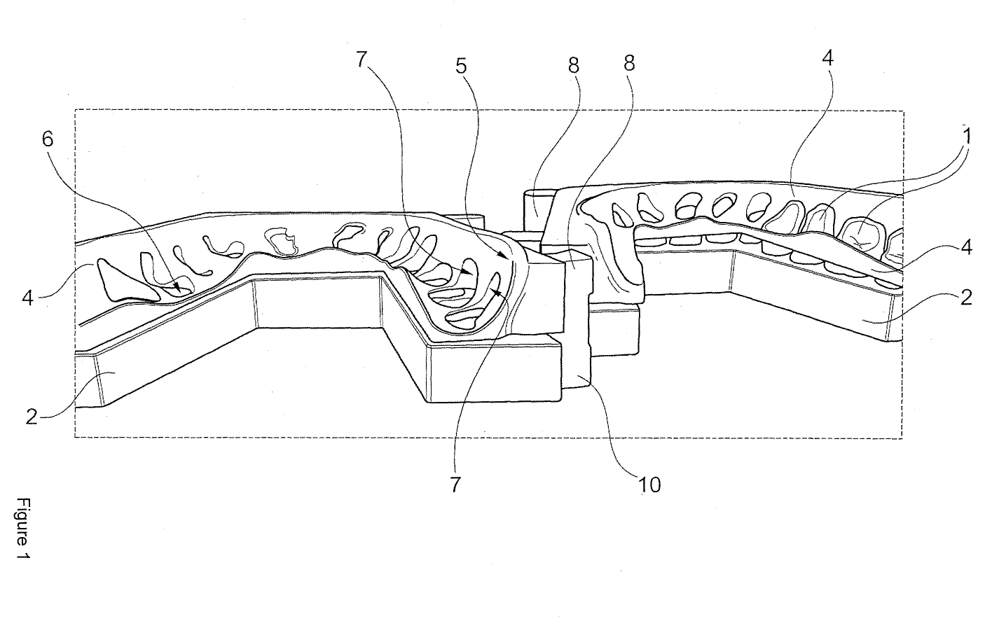

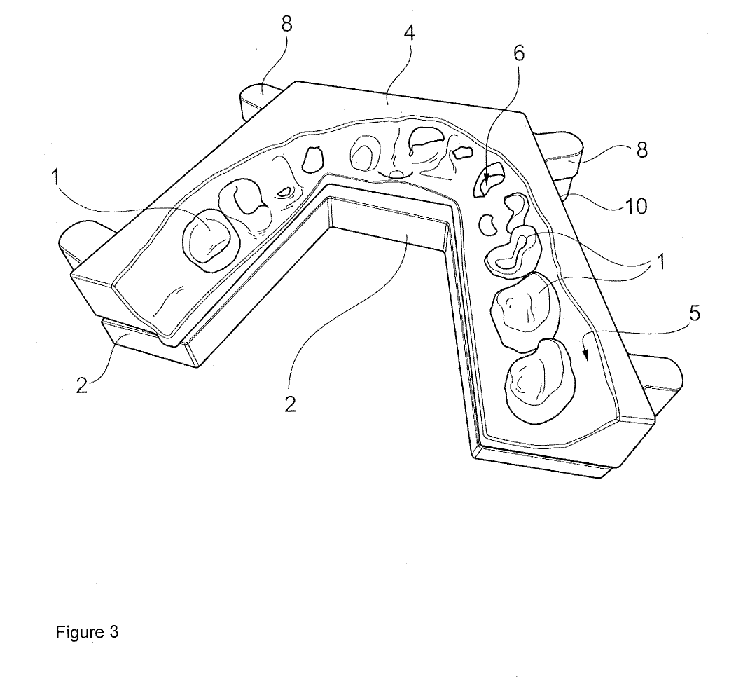

FIG. 1 shows a schematic perspective side view on two tooth cutting guides or tooth ridge lap guides according to the invention. FIG. 3 shows a schematic perspective view on top of a tooth cutting guide or tooth ridge lap guide according to FIG. 1 having prefabricated artificial teeth 1 inserted.

The tooth cutting guide or tooth ridge lap guide on the right side of FIG. 1 is shown having inserted prefabricated artificial teeth 1, while tooth cutting guide or tooth ridge lap guide on the left side is shown without artificial teeth. The tooth cutting guides or tooth ridge lap guides have a holding element 2 as a lower part and a base body 4 in form of a jig as an upper part. The upper side of the base body 4 has an inner wall 5, which height and shape is defined by the limits of basal sides of a virtual model of processed prefabricated artificial teeth which suit to an individual denture base of an individual denture, which has been calculated from virtual models of an oral cavity situation of a patient and of a set of prefabricated artificial teeth 1, from which the denture will be manufactured.

The base body 4 comprises through holes 6 through which the basal sides of the unprocessed prefabricated teeth 1 protrude. The borders of the through holes 6 in the inner wall 5 of the base body 4 define a line to which the inserted prefabricated artificial teeth 1 are to be cut or milled, so that the so processed prefabricated artificial teeth will fit to a denture base according to the virtual model of the denture. For this purpose, the borders of the through holes 6 and the adjoining surface areas of the base body 4 are built to be in contact and form fit to the inserted prefabricated artificial teeth 1. These adjoining areas build retainers 7 for the prefabricated artificial teeth 1 in the base body 4. The retainers 7 hold the prefabricated artificial teeth 1 in place by form fitting to their surface areas surrounding the border lines defined by the through holes 6 in an occlusal direction.

The occlusal side of the prefabricated artificial teeth 1 are held by the holding element 2, which secures the prefabricated artificial teeth 1 from falling out of the retainers 7 and holds them in the correct position with respect to a Z-axis of the prefabricated artificial teeth 1 which is aligned from the basal to the occlusal side of the prefabricated artificial teeth 1. The relative position and alignment of the holding element 2 and the base body 4 relative to one another are defined by the inserted prefabricated artificial teeth 1 and are additionally defined by fixing elements 8, 10 being fixed to the holding element 2 and to the base body 4. Because of that the tooth cutting guide or tooth ridge lap guide can easily be handled by the technician or worker who mills or cuts the prefabricated artificial teeth 1 basally by hand according to the form defined by the through holes 6.

After the prefabricated artificial teeth 1 have been manually basally abraded by milling or cutting they are inserted and glued or fixed otherwise into sockets of a denture base (not shown) which is manufactured according to a virtual model of the denture base, which is calculated from a virtual model of the denture, as known from the state of the art. Thereby a complete denture is produced which can afterwards be finished by polishing and removing excess glue.

The tooth cutting guide or tooth ridge lap guide for processing the prefabricated artificial teeth 1, is manufactured by first calculating the virtual model of a denture based on data from a virtual model of an oral cavity of a patient and data from virtual models of prefabricated artificial teeth from a set of prefabricated artificial teeth. The virtual model of the oral cavity can be produced by directly scanning the oral cavity at the patient or by scanning an impression of the oral cavity which is taken at the patient. Methods to calculate the virtual denture are known from the state of the art. Next, as a second step, the virtual model of the denture is separated into a virtual model of a denture base and a virtual model of processed prefabricated artificial teeth such that the virtual model of the processed prefabricated artificial teeth form fits to sockets in the virtual denture base. Such techniques are also known from the state of the art. As a third step, a difference in shape of the virtual model of the processed prefabricated artificial teeth compared to the virtual model of the prefabricated artificial teeth is calculated by using Boolean operations analogue to the calculation of the virtual models of the denture, the denture base and the processed artificial teeth. The fourth step is calculating at least one virtual model of the tooth cutting guide or tooth ridge lap guide from the virtual model of the prefabricated artificial teeth and the calculated difference in shape, wherein the tooth cutting guide or tooth ridge lap guide comprises a virtual model of the base body 4 which comprises retainers 7 for each of the prefabricated artificial teeth 1. The inner surfaces of each retainer 7 is calculated to have a form fit to a first surface area of the virtual model of the prefabricated artificial teeth 1 in areas where there is no difference in shape compared to the virtual model of the processed prefabricated artificial teeth. Furthermore, the through holes 6 are calculated into the virtual model of the tooth cutting guide or tooth ridge lap guide inside the virtual model of the base body 4, the through holes 6 being located in the retainers 7, wherein borders of the through holes 6 being defined by the boundaries of the difference in shape of the virtual model of the processed prefabricated artificial teeth compared to the virtual model of the prefabricated artificial teeth 1. As a last step the base body 4 can easily be manufactured by means of a CAM method like RP methods. Preferably, the base body 4 is printed using a 3D printer.

The virtual model of the denture can be calculated by defining a contact area for the virtual model of the denture base, which is calculated from the virtual model of the oral cavity of the patient, placing the virtual models of the prefabricated artificial teeth inside the virtual model of the oral cavity taking patient specifics like the occlusion or the articulation into account, calculating the virtual model of the denture by adding volume to the contact area such that the virtual models of the prefabricated artificial teeth are embedded on their base side and such that interdental papilla are formed, and calculating the virtual model of the processed prefabricated artificial teeth by basally shortening the virtual models of the prefabricated artificial teeth or by occlusally shortening and moving the virtual models of the prefabricated artificial teeth in an occlusal direction, such that the virtual model of the denture base gains a minimum thickness and sockets are formed which basally form fit the virtual model of the processed prefabricated artificial teeth in areas.

The holding element 2 is manufactured by calculating a virtual model of the holding element 2 as an additional part of the virtual model of the at least one tooth cutting guide or tooth ridge lap guide. It can be provided that a multitude plurality of recesses (not shown) are calculated into the virtual model of the holding element 2, each one for the occlusal side of each of the prefabricated artificial teeth 1, wherein an inner surface of each of the recesses form fits to the occlusal surface of one of the virtual models of the prefabricated artificial teeth 1. This allows the holding element 2 to readily fix the prefabricated artificial teeth 1 in the tooth cutting guide or tooth ridge lap guide.

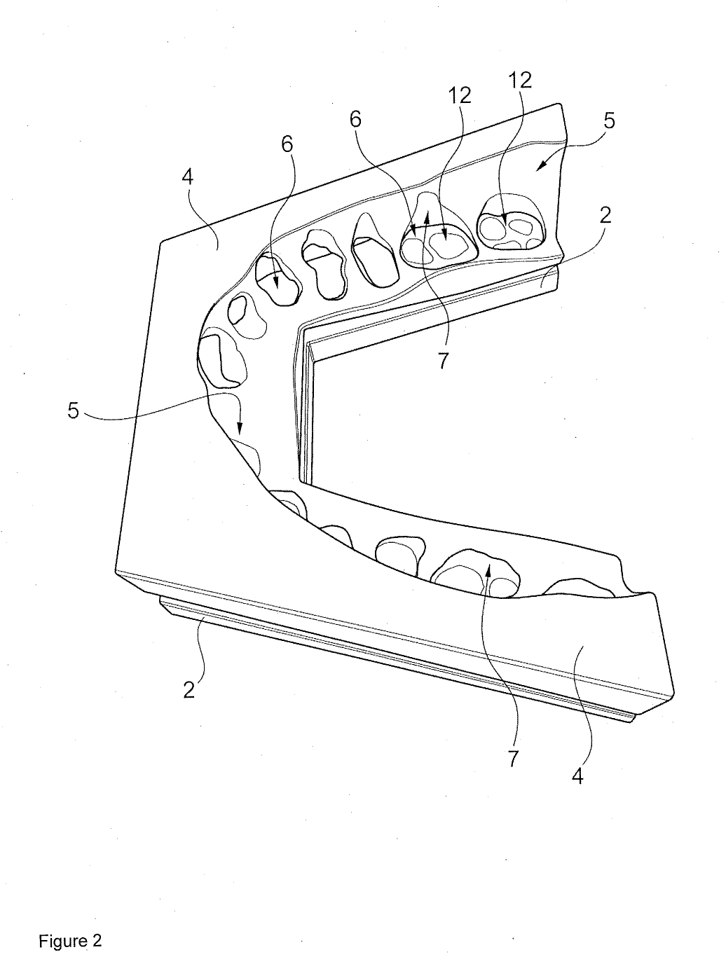

FIG. 2 shows a schematic perspective view on top of a tooth cutting guide or tooth ridge lap guide according to the invention. The tooth cutting guide or tooth ridge lap guide comprises a base body 4 and a holding element 2 which are stacked upon each other. The base body 4 comprises through holes 6 which end in an inner wall 5 of the base body 4. The inner wall 5 has a height and a shape which is defined by the limits of basal sides of a virtual model of processed prefabricated artificial teeth which fit to an individual denture base of an individual denture, which has been calculated from virtual models of an oral cavity situation of a patient and of a set of prefabricated artificial teeth, from which the denture will be manufactured. The borders of the through holes 6 in the inner wall 5 of the base body 4 define a line to which prefabricated artificial teeth (not shown in FIG. 2), which are to be inserted, are to be cut down or milled down, so that the so processed prefabricated artificial teeth will fit to a denture base according to a certain and individual virtual model of the denture. For this purpose, the borders of the through holes 6 and the adjoining surface areas of the base body 4 are in contact and form fit to the inserted prefabricated artificial teeth. These adjoining areas build retainers 7 for the prefabricated artificial teeth in the base body 4. The retainers 7 hold the prefabricated artificial teeth 1 in place by form fitting to their surface areas surrounding the border lines defined by the through holes 6 in an occlusal direction.

The occlusal side of the prefabricated artificial teeth (not shown) are held by the holding element 2, which secures the prefabricated artificial teeth from falling out of the retainers 7 and holds them in the correct position with respect to a Z-axis of the prefabricated artificial teeth. The holding element 2 is formed like a plate and comprises recesses 12 for each prefabricated artificial tooth to be inserted. These recesses 12 form fit to the occlusal cups of the prefabricated artificial teeth. The relative position and alignment of the holding element 2 and the base body 4 relative to one another are defined by the inserted prefabricated artificial teeth.

After the prefabricated artificial teeth have been manually basally abraded by milling or cutting they are inserted and glued or fixed otherwise into sockets of a denture base (not shown) which is manufactured according to a virtual model of the denture base, which is calculated from a virtual model of the denture, as known from the state of the art. Thereby a complete denture is produced which can afterwards be finished by polishing and removing excess glue.

The tooth cutting guide or tooth ridge lap guide itself is produced like described in the previous embodiment according to FIG. 1.

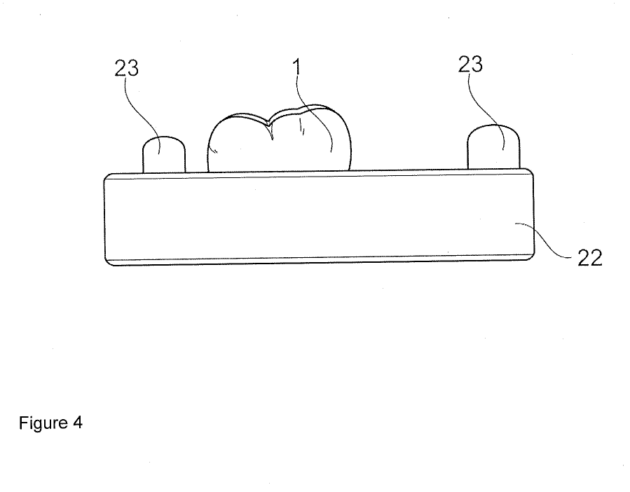

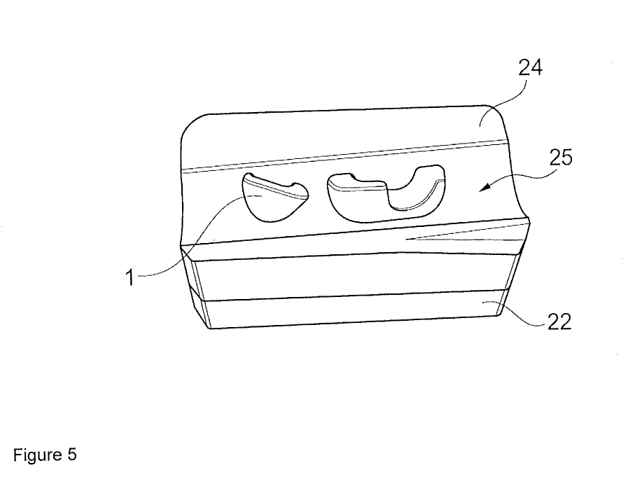

FIGS. 4 and 5 show a schematic side view on a holding element 22 of an alternative tooth cutting guide or tooth ridge lap guide and a schematic perspective view on the tooth cutting guide or tooth ridge lap guide according to the present invention. The tooth cutting guide or tooth ridge lap guide comprises the holding element 22 and a base body 24. The tooth cutting guide or tooth ridge lap guide according to this embodiment can hold two prefabricated artificial teeth 1, basal ends of which partly protrude through two through holes, which are located in two retainers in the base body 24. The retainers form fit areas of the two prefabricated artificial teeth 1 adjacent to the two through holes. The holding element 22 secures the two prefabricated artificial teeth 1 in the two retainers of the base body 24. Apart from being applicable for only two prefabricated artificial teeth the embodiment according to FIGS. 4 and 5 is similar to the previous embodiments and can be manufactured using the same method.

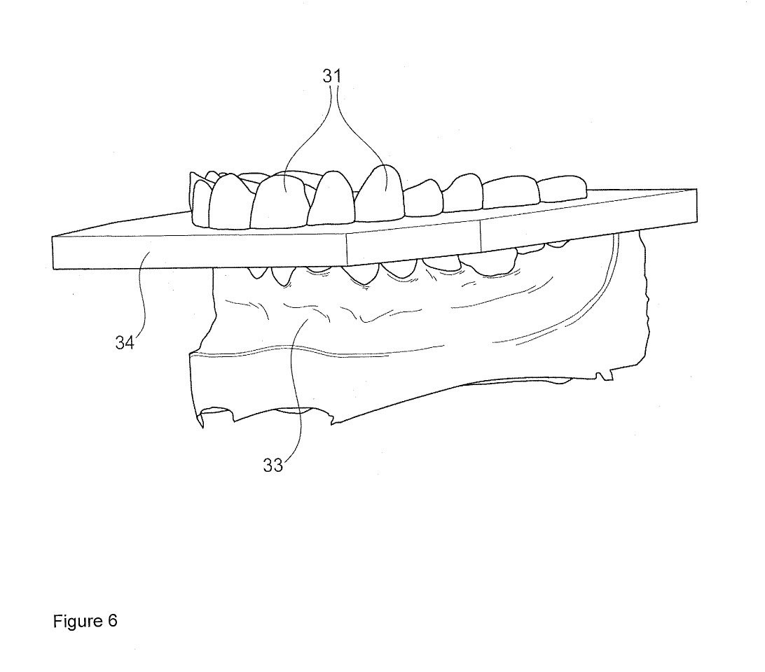

FIG. 6 shows a virtual model for generating a tooth cutting guide or tooth ridge lap guide according to the present invention, by which the occlusal sides of a set of prefabricated artificial teeth can be manually milled or cut. This virtual model comprises a virtual model of a set of artificial teeth 31 and a virtual model of a lower jaw 33 comprising mucosa and teeth. In the virtual model the set of artificial teeth 31 are brought to a desired occlusion with the teeth of the virtual model of the lower jaw 33. The virtual model of the set of artificial teeth 31 and the teeth of the virtual model of the lower jaw 33 partially overlap, because the artificial teeth 31 have been positioned so the virtual model of the set of artificial teeth 31 fit to a virtual denture base (not shown) which together form a virtual model for a specific full denture for the upper jaw of a patient. At the overlap, the teeth 31 for the upper denture and the teeth of the lower jaw 33 share a volume in the virtual model shown in FIG. 6.

In the contact area of the virtual artificial teeth 31 and the virtual models of the teeth of the lower jaw 33, a virtual model of a base body 34 in form of a disk is created in which the overlaps and the shared volumes of the teeth 31 for the upper denture and the teeth of the lower jaw 33 are included as well as a volume around these areas. The overlaps and the shared volumes and the thickness of the areas surrounding them define the thickness of the disk shaped base body 34. The virtual model of the base body 34 is calculated by Boolean operations so that the surfaces of the teeth 31 for the upper denture and the surfaces of the teeth of the lower jaw 33 are used to create formfitting negative surfaces in the virtual model of the base body 34. The areas in the virtual model of the base body 34 which are formed by the shape of the virtual models of the teeth 31 will become retainers and the lines which border the overlapping shared volumes will define the through holes of the base body, which is produced from the virtual model of the base body 34.

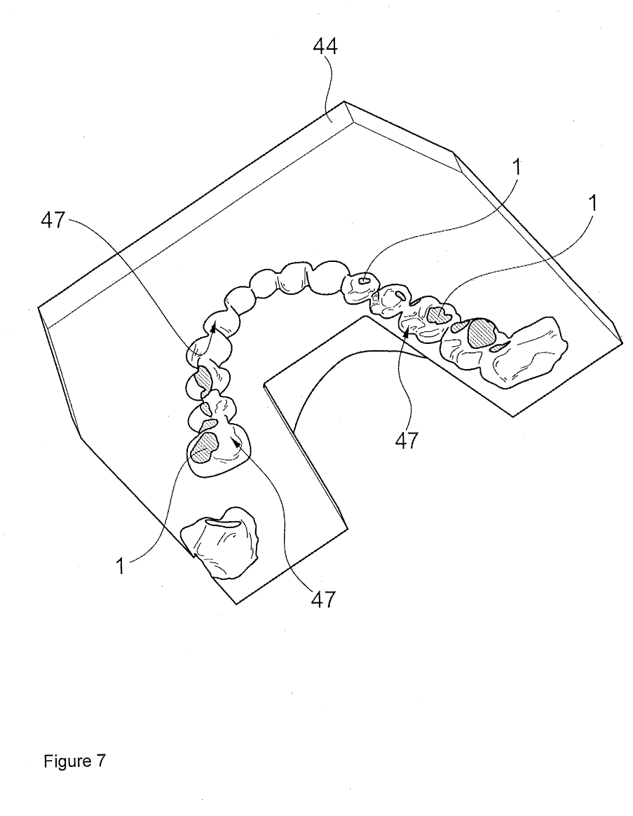

FIG. 7 shows a base body 44 produced by a CAM-method, preferably simply produced by 3D printing, from the virtual model of the base body 34 according to FIG. 6. The base body 44 having retainers 47 and through holes through which cups of a set of prefabricated artificial teeth 1 for producing an upper denture protrude. The artificial teeth 1 are placed in retainers on the opposite side of the base body 44. The bass body 44 is a tooth cutting guide or tooth ridge lap guide, which can be used for reducing the heights of the artificial teeth 1 according to the virtual model shown in FIG. 6. The protruding parts of the cups of the artificial teeth 1 can easily be cut or milled by a technician and fixed to a denture base (not shown), which was produced according to the model used in the previous step according to FIG. 6. Because of the model according to FIG. 6, a full denture for the upper jaw can be generated from the so processed artificial teeth 1, by gluing the processed artificial teeth 1 in a denture base produced from the virtual model of the denture base.

Apart from being applicable to process the occlusal sides of prefabricated artificial teeth 1 the embodiment according to FIG. 7 is similar to the previous embodiments and can be manufactured using a corresponding method.

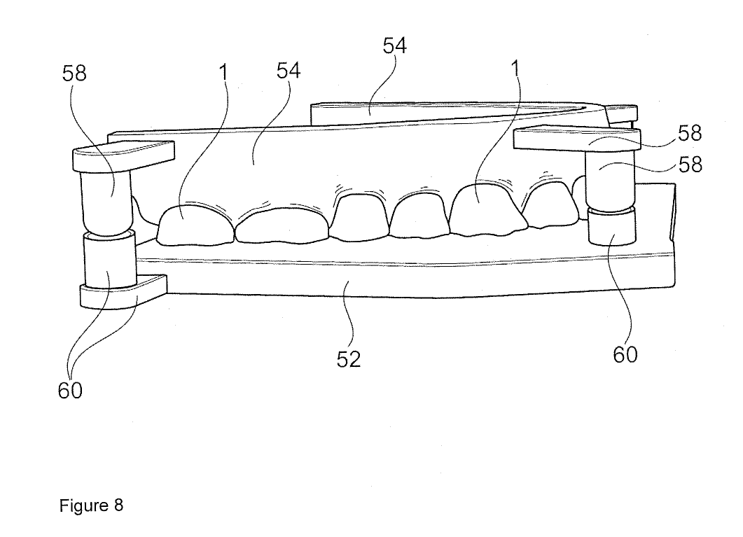

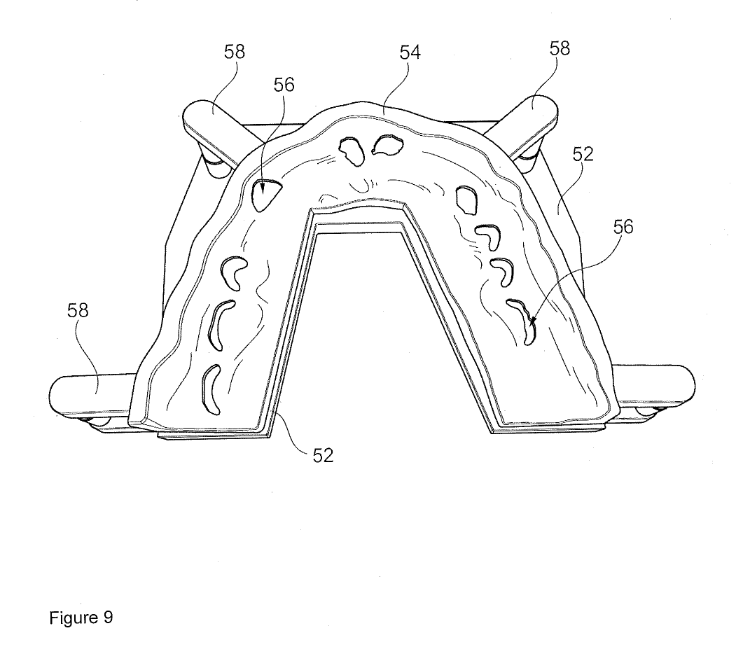

FIGS. 8 and 9 show a tooth cutting guide or tooth ridge lap guide having a base body 54 to be used as a jig for basally processing a set of artificial teeth 1 for an upper denture for the upper jaw by milling or cutting the basal sides of the artificial teeth 1. The tooth cutting guide or tooth ridge lap guide further having a holding element 52, which holds the artificial teeth 1 inside the base body 54 in position. The relative position of the base body 54 and the holding element 52 is defined and can easily be held in position by means of fixing elements 58, 60, four of which are provided on each of the holding element 52 and the base body 54, on different sides. The prefabricated artificial teeth 1 inserted in the tooth cutting guide or tooth ridge lap guide can easily be milled or cut where they protrude through holes 56 in retainers fitting to basal areas of the artificial teeth 1. FIG. 8 shows the tooth cutting guide or tooth ridge lap guide having the artificial teeth 1 inserted and FIG. 9 shows the tooth cutting guide or tooth ridge lap guide without artificial teeth, so that the through holes 56 can be easily recognized.

The embodiment according to FIGS. 8 and 9 is similar to the previous embodiment according to FIGS. 1 and 3 and can be manufactured using the same method.

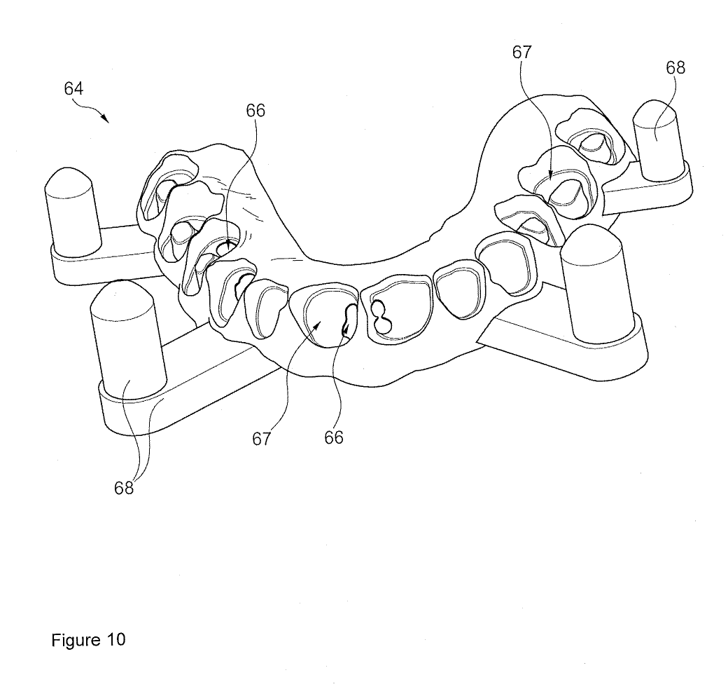

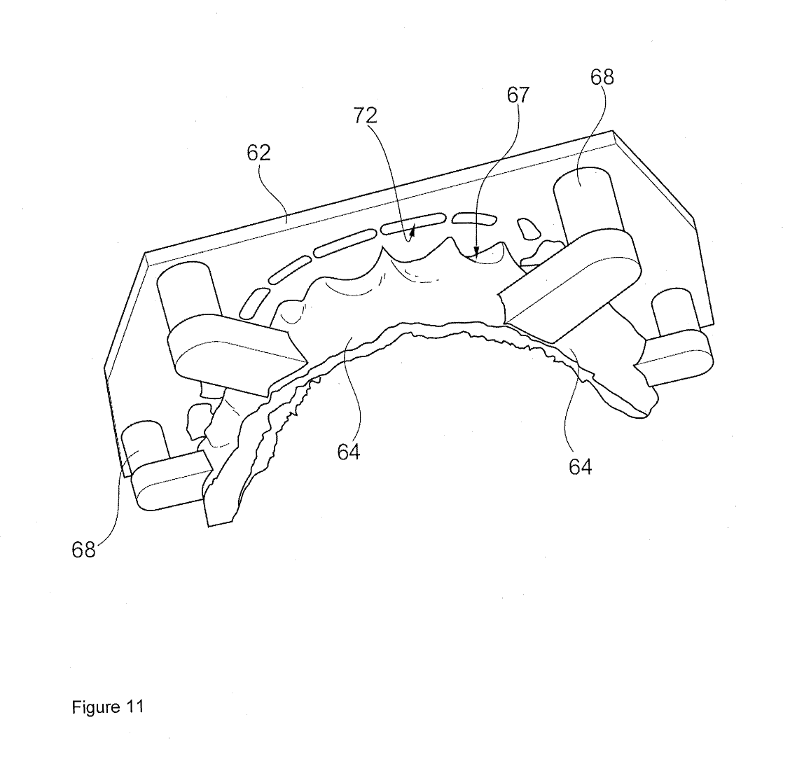

FIG. 10 shows a base body 64 of a tooth cutting guide or tooth ridge lap guide to be used as a jig for basally processing a set of artificial teeth (not shown) for a lower denture for the lower jaw by milling or cutting the basal sides of the artificial teeth. FIGS. 10 and 11 shows the whole tooth cutting guide or tooth ridge lap guide further having a disk-shaped holding element 62, which holds inserted artificial teeth inside the base body 64 in position. For this purpose, recesses 72 are formed in the holding element 62, which have the shape of occlusal surfaces of the artificial teeth to be inserted. The relative position of the base body 64 and the holding element 62 is defined and can easily be held in position by means of fixing elements 68, four of which are provided on the base body 64, on different sides. The holding element 62 comprises indentations which form fit the ends of the fixing elements 68. The prefabricated artificial teeth inserted in the tooth cutting guide or tooth ridge lap guide can easily be milled or cut where they protrude through holes 66 in retainers 67 fitting to basal areas of the artificial teeth. FIG. 10 shows the base body 64 only and FIG. 11 shows both parts of the tooth cutting guide or tooth ridge lap guide without artificial teeth.

The embodiment according to FIGS. 10 and 11, which, apart from being suited to process artificial teeth for the lower jaw, is similar to the previous embodiment according to FIGS. 8 and 9 and can be manufactured using the same method.

The features of the invention disclosed in the above description, the claims, Figures, and exemplary embodiments can be essential both individually and in any combination for implementing the various embodiments of the invention.

### LIST OF REFERENCE SYMBOLS

1 artificial teeth
2 holding element
4 base body
5 inner wall
6 through hole
7 retainer
8 fixing element
10 fixing element
12 recess
22 holding element
24 base body
25 inner wall
31 virtual artificial teeth
33 virtual model of lower jaw
34 virtual model of base body
44 base body
47 retainer
52 holding element
54 base body
56 through hole
58 fixing element
60 fixing element
62 holding element
64 base body
66 through hole
67 retainer
68 fixing element
72 recess

1. Tooth cutting guide or tooth ridge lap guide for processing at least one prefabricated artificial tooth from a set of prefabricated artificial teeth using a subtractive processing method, the tooth cutting guide or tooth ridge lap guide comprising:
a base body,
at least one retainer for receiving and positioning the at least one prefabricated artificial tooth, which is formed in the base body, wherein an inner surface of each of the at least one retainer form fits to a first surface area of one of the at least one prefabricated artificial tooth from the set of prefabricated artificial teeth, and
at least one through hole which is located in the at least one retainer, wherein the at least one through hole exposes at least a part of a basal surface or an occlusal surface of the one of the at least one prefabricated artificial tooth if inserted into a corresponding retainer.

2. Tooth cutting guide or tooth ridge lap guide according to claim 1, wherein the at least one prefabricated artificial tooth is insertable from a first side of the base body into the at least one retainer and at least the part of the basal surface or occlusal surface of the one of the at least one prefabricated artificial tooth is processable from a second side of the base body opposite the first side of the base body, if the at least one prefabricated artificial tooth is inserted into the corresponding retainer.

3. Tooth cutting guide or tooth ridge lap guide according to claim 1, wherein the base body is produced using a CAM method or is printed using a 3D printer.

4. Tooth cutting guide or tooth ridge lap guide according to claim 3, wherein the base body is produced using a CAD method which is calculated from:
A) a virtual denture model which fits to a specific patient and the virtual denture model is separated into a virtual model of a denture base and at least one virtual model of the at least one processed artificial tooth which is processable from the at least one prefabricated artificial tooth using the subtractive processing method, and
B) at least one virtual model of the set of prefabricated artificial teeth.

5. Tooth cutting guide or tooth ridge lap guide according to claim 1, wherein a basal part or an occlusal part of the one of the at least one prefabricated artificial tooth protrudes through the at least one through hole, if the one of the at least one prefabricated artificial tooth is inserted into the corresponding retainer.

6. Tooth cutting guide or tooth ridge lap guide according to claim 1, wherein the base body is made from a plastic material or a printing resin.

7. Tooth cutting guide or tooth ridge lap guide according to claim 6, wherein the plastic material or the printing resin has a hardness which is lesser than a hardness of the material of the at least one prefabricated artificial tooth.

8. Tooth cutting guide or tooth ridge lap guide according to claim 1, wherein the inner surface of the at least one retainer form fits the one of the at least one prefabricated artificial tooth bordering on the at least one through hole.

9. Tooth cutting guide or tooth ridge lap guide according to claim 1, wherein the material of the base body has a strength of less than 1 mm in the area of the at least one retainer which covers the basal surface or the occlusal surface of each of the at least one prefabricated artificial tooth inserted into the corresponding retainer.

10. Tooth cutting guide or tooth ridge lap guide according to claim 1, wherein the base body has a color or surface eliciting a visible contrast to the at least one prefabricated artificial tooth.

11. Tooth cutting guide or tooth ridge lap guide according to claim 1, wherein the tooth cutting guide or tooth ridge lap guide further comprises a holding element, which holds the at least one specific prefabricated artificial tooth in the at least one retainer.

12. Tooth cutting guide or tooth ridge lap guide according to claim 11, wherein the holding element is fixed or fixable to the base body by fixing means.

13. Tooth cutting guide or tooth ridge lap guide according to claim 12, wherein the fixing means are part of the holding element or part of the base body or part of both the holding element and the base body.

14. Tooth cutting guide or tooth ridge lap guide according to claim 11, wherein the holding element comprises at least one recess, each one for each of the at least one prefabricated artificial tooth, wherein an inner surface of each of the at least one recess form fits to a second surface area of one of the at least one prefabricated artificial tooth from the set of prefabricated artificial teeth.

15. Tooth cutting guide or tooth ridge lap guide according to claim 14, wherein the second surface area of the one of the at least one prefabricated artificial tooth is located on the opposite side of the first surface area of the one of the at least one prefabricated artificial tooth, which form fits the inner surface of each of the at least one retainer.

16. Tooth cutting guide or tooth ridge lap guide for processing at least two prefabricated artificial teeth of a set of prefabricated artificial teeth using a subtractive processing method, the tooth cutting guide or tooth ridge lap guide comprising:
a base body,
a plurality of retainers for receiving and positioning a plurality of prefabricated artificial teeth which are formed in the base body, wherein inner surfaces of each retainer form fits to a first surface area of one of the plurality of prefabricated artificial teeth from the set of prefabricated artificial teeth, and
at least two through holes which are located in more than one of the plurality of retainers, wherein the at least two through holes each expose at least a part of a basal surface or an occlusal surface of at least two of the plurality of prefabricated artificial teeth if inserted into a corresponding retainer.

17. Tooth cutting guide or tooth ridge lap guide according to claim 16, wherein the prefabricated artificial teeth are insertable from a first side of the base body into the retainers and at least the part of the basal surface or the occlusal surface of the at least two of the plurality of prefabricated artificial teeth are processable from a second side of the base body opposite the first side of the base body.

18. Tooth cutting guide or tooth ridge lap guide according to claim 16, wherein the base body is produced using a CAM method or is printed using a 3D printer.

19. Tooth cutting guide or tooth ridge lap guide according to claim 18, wherein the base body is produced using a CAD method which is calculated from
A) a virtual denture model which fits to a specific patient and the virtual denture model is separated into a virtual model of a denture base and at least one virtual model of a plurality of processed artificial teeth which are processable from the plurality of prefabricated artificial teeth using the subtractive processing method, and
B) virtual models of the set of prefabricated artificial teeth.

20. Tooth cutting guide or tooth ridge lap guide according to claim 16, wherein a basal part or an occlusal part of the at least two of the plurality of prefabricated artificial teeth protrude through the at least two through holes if the at least two of the plurality of prefabricated artificial teeth are inserted into the corresponding retainers.

21. Tooth cutting guide or tooth ridge lap guide according to claim 16, wherein the base body is made from a plastic material or a printing resin.

22. Tooth cutting guide or tooth ridge lap guide according to claim 21, wherein the plastic material or the printing resin has a hardness which is lesser than a hardness of the material of the prefabricated artificial teeth.

23. Tooth cutting guide or tooth ridge lap guide according to claim 16, wherein the inner surfaces of the retainer's form fit the at least two prefabricated artificial teeth bordering on the at least two through holes.

24. Tooth cutting guide or tooth ridge lap guide according to claim 16, wherein the material of the base body has a strength of less than 1 mm in the area of the plurality of retainers which covers the basal surface or the occlusal surface of the plurality of prefabricated artificial teeth if inserted into the corresponding retainer.

25. Tooth cutting guide or tooth ridge lap guide according to claim 16, wherein the base body has a color or surface eliciting a visible contrast to the at least two prefabricated artificial teeth.

26. Tooth cutting guide or tooth ridge lap guide according to claim 16, wherein the tooth cutting guide or tooth ridge lap guide further comprises a holding element, which holds the plurality of prefabricated artificial teeth in the plurality of retainers.

27. Tooth cutting guide or tooth ridge lap guide according to claim 26, wherein the holding element is fixed or fixable to the base body by fixing means.

28. Tooth cutting guide or tooth ridge lap guide according to claim 27, wherein the fixing means are part of the holding element or part of the base body or part of both the holding element and the base body.

29. Tooth cutting guide or tooth ridge lap guide according to claim 26, wherein the holding element comprises a plurality of recesses, each one for each of the plurality of prefabricated artificial teeth, wherein an inner surface of each of the recesses form fits to a second surface area of one of the plurality of prefabricated artificial teeth from the set of prefabricated artificial teeth.

30. Tooth cutting guide or tooth ridge lap guide according to claim 29, wherein the second surface area of the one of the plurality of prefabricated artificial teeth is located on the opposite side of the first surface area of each one of the plurality of prefabricated artificial teeth, which form fits the inner surface of each retainer in the base body.

31. Method for manufacturing at least one tooth cutting guide or tooth ridge lap guide for processing prefabricated artificial teeth, the method comprising the following steps:
calculating a virtual model of a denture based on data from a virtual model of an oral cavity of a patient and data of virtual models of prefabricated artificial teeth from a set of prefabricated artificial teeth,
separating the virtual model of the denture into a virtual model of a denture base and a virtual model of processed prefabricated artificial teeth such that the virtual model of the processed prefabricated artificial teeth form fits to sockets in the virtual model of the denture base,
calculating a difference in shape of the virtual model of the processed prefabricated artificial teeth compared to the virtual model of the prefabricated artificial teeth,
calculating at least one virtual model of at least one tooth cutting guide or tooth ridge lap guide from the virtual model of the prefabricated artificial teeth and the calculated difference in shape, wherein each of the at least one virtual model of the tooth cutting guide or tooth ridge lap guide comprises a virtual model of a base body which comprises or which each comprise retainers for each of the prefabricated artificial teeth,
calculating inner surfaces of each retainer to have a form fit to a first surface area of the virtual model of the prefabricated artificial teeth in areas where there is no difference in shape compared to the virtual model of the processed prefabricated artificial teeth,
calculating through holes into the virtual model of the at least one tooth cutting guide or tooth ridge lap guide inside the virtual model of the base body, the through holes being located in the retainers, wherein borders of the through holes being defined by boundaries of the difference in shape of the virtual model of the processed prefabricated artificial teeth compared to the virtual model of the prefabricated artificial teeth, and
manufacturing the at least one tooth cutting guide or tooth ridge lap guide by a CAM method.

32. Method according to claim 31, comprising calculating the virtual model of the denture by:
defining a contact area for the virtual model of the denture base, which is calculated from the virtual model of the oral cavity of the patient,
placing the virtual models of the prefabricated artificial teeth inside the virtual model of the oral cavity taking patient specifics into account,
calculating the virtual model of the denture by adding volume to the contact area such that the virtual models of the prefabricated artificial teeth are embedded on their base side and such that interdental papilla are formed, and
calculating the virtual model of the processed prefabricated artificial teeth by basally shortening the virtual models of the prefabricated artificial teeth or by occlusally shortening and moving the virtual models of the prefabricated artificial teeth in an occlusal direction such that the virtual model of the denture base gains a minimum thickness and sockets are formed which basally form fit the virtual model of the processed prefabricated artificial teeth in areas.

33. Method according to claim 31, comprising:
calculating a virtual model of at least one holding element as an additional part of the virtual model of the at least one tooth cutting guide or tooth ridge lap guide, and
locating a plurality of recesses in the virtual model of the at least one holding element, each one for each of the prefabricated artificial teeth, wherein an inner surface of each of the recesses form fits to a second surface area of one of the virtual models of the processed prefabricated artificial teeth.

34. Method according to claim 31, comprising calculating the virtual model of the at least one tooth cutting guide or tooth ridge lap to either be:
A) one virtual model of one tooth cutting guide or tooth ridge lap guide for each of the prefabricated artificial teeth, or
B) one or more virtual models of at least two tooth cutting guides or at least two tooth ridge lap guides for groups of at least two of the prefabricated artificial teeth, or
C) one virtual model of one tooth cutting guide or tooth ridge lap guide for all of the prefabricated artificial teeth.

35. Method for producing a denture using a method according to claim 31, comprising:
placing the prefabricated artificial teeth in the retainers of the at least one tooth cutting guide or tooth ridge lap guide,
subtractively processing the prefabricated artificial teeth in areas which are exposed by the through holes,
manufacturing a denture base by using a CAM method based on the virtual model of the denture base, and
inserting and fixing the processed prefabricated artificial teeth into sockets of the denture base.
